(19) United States
(12) Patent Application Publication
(10) Pub. No.: US 2022/0309466 A1
(43) Pub. Date: Sep. 29, 2022

(54) DETECTING AND MITIGATING SENSITIVE EXPRESSION DURING A MEETING

(71) Applicant: International Business Machines Corporation, Armonk, NY (US)

(72) Inventors: Rodolfo Lopez, Austin, TX (US); Feiqi Zhu, Austin, TX (US); Jesus R. Acevedo, Tucson, AZ (US); Roger Strommen, Pima, AZ (US); Jason Evans Willerup, Sahuarita, AZ (US); Monica J. Lemay, Cedar Park, TX (US)

(21) Appl. No.: 17/216,001

(22) Filed: Mar. 29, 2021

(51) Int. Cl. G06Q 10/10; G06Q 50/00

(52) U.S. Cl. CPC G06Q 10/105; G06Q 10/1095; G06Q 50/01

(57) ABSTRACT

An approach to detecting a sensitive expression during a meeting and alerting a meeting attendee producing the sensitive expression. The approach can retrieve a list of meeting attendees from a meeting scheduler database. The approach can retrieve societal data associated with the list of meeting attendees. The approach can capture audio and/or video of the meeting attendees during the meeting. The approach can detect a sensitive expression by a meeting attendee based on an analysis of the societal data and the audio and or video of the meeting. The approach can send an alert to the meeting attendee conducting the sensitive expression to mitigate further conduct.

### TECHNICAL FIELD

The present invention relates generally to electronic conferencing, and more specifically, to inappropriate word, phrase or gesture identification and remediation.

### BACKGROUND

Electronic communication has evolved to the point where collaboration through computer-based tools for video conferencing have become ubiquitous in our workplace environment. A large portion of the workforce uses audio and/or video conferencing for interaction with coworkers, clients and customers. Similarly, personal communications have adopted this technology for seamless interaction with family and friends. For example, Google Hangouts, Skype, Facetime, etc. Furthermore, many social network platforms such as Facebook, LinkedIn, etc. provide electronic communication embedded within their platform. On some occasions, users of these technologies use an inappropriate word or phrases that are inappropriate at all times, inappropriate for the context or inappropriate for the current circumstances.

There are instances where a meeting attendee of a geographically dispersed meeting uses a phrase that, at the time, is insensitive, e.g., after a disaster such as large wildfire, it would be inappropriate to use terms such as “burn,” “scorch” or “blaze” during meetings where the terms might be perceived by some as insensitive in context. Similarly, after a publicized crime involving a firearm, terms such as “trigger,” “postal” or “massacre” might be sensitive to one or more meeting attendees.

A need has evolved for accommodating different geographically dispersed teams where their cultural or social differences might be distinct, or for some meeting attendees, the current news might make them perceive certain terms or topics as too sensitive, or sad to discuss.

### BRIEF SUMMARY

According to an embodiment of the present invention, a computer-implemented method for detecting a sensitive expression during a meeting and alerting one or more meeting attendees, the computer-implemented method comprising: retrieving a list of meeting attendees from a meeting scheduler database; retrieving societal data associated with the list of meeting attendees; capturing at least one of audio or video of the meeting; detecting a sensitive expression by a meeting attendee based on an analysis of the societal data and one or more of meeting attendee input and the at least one of audio or video; sending an alert to the meeting attendee based on the detecting; and sending an action notice to the list of meeting attendees based on the detecting.

According to an embodiment of the present invention, a computer program product for detecting a sensitive expression during a meeting and alerting one or more meeting attendees, the computer program product comprising: one or more non-transitory computer readable storage media and program instructions stored on the one or more non-transitory computer readable storage media, the program instructions comprising: program instructions to retrieve a list of meeting attendees from a meeting scheduler database; program instructions to retrieve societal data associated with the list of meeting attendees; program instructions to capture at least one of audio or video of the meeting; program instructions to detect a sensitive expression by a meeting attendee based on an analysis of the societal data and one or more of meeting attendee input and the at least one of audio or video; program instructions to send an alert to the meeting attendee based on the detecting; and program instructions to send an action notice to the list of meeting attendees based on the detecting.

According to an embodiment of the present invention, A computer system for detecting a sensitive expression during a meeting and alerting one or more meeting attendees, the computer system comprising: one or more computer processors; one or more non-transitory computer readable storage media; and program instructions stored on the one or more non-transitory computer readable storage media, the program instructions comprising: program instructions to retrieve a list of meeting attendees from a meeting scheduler database; program instructions to retrieve societal data associated with the list of meeting attendees; program instructions to capture at least one of audio or video of the meeting; program instructions to detect a sensitive expression by a meeting attendee based on an analysis of the societal data and one or more of meeting attendee input and the at least one of audio or video; program instructions to send an alert to the meeting attendee based on the detecting; and program instructions to send an action notice to the list of meeting attendees based on the detecting.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of detecting a sensitive expression during a meeting and alerting a meeting attendee producing the sensitive expression. It should be noted that embodiments of the present invention can be configured to provide an action notice to meeting attendees that an expression that may be interpreted as insensitive has been detected and actions are being taken to prevent future occurrences. It should be noted that the term software, as used herein, includes any type of computer instructions such as, but not limited to, firmware, microcode, etc.

Embodiments of the present invention can monitor, in real-time, meeting attendees for sensitive expression with regard to speech and gestures based on observing audio, video and user input during a meeting. It should be noted that if video is not available, a question-and-answer mechanism, e.g., a data entry form with fields such as, but not limited to, one or more check-boxes, one or more radio-buttons, one or more scroll-bars, etc., can be employed to detect sensitive gestures based on a gesture-to-sentiment mapping database created from past meetings of an attendee.

In another aspect, embodiments of the present invention can interact with current news sources, local, national and international, social media, and social network databases to retrieve recent data to create a sentiment classification database for meeting attendees.

Embodiments of the present invention, with the aforementioned data in hand, can analyze and correlate, in real-time, detected gestures and the reaction to the gestures as perceived by the meeting attendees in light of current information, e.g., news, from social media or cultural information databases. The results of the analysis can be stored in attendee specific profiles for current use and for use in attendee future meetings.

In another aspect, embodiments of the present invention can provide alert communications to a meeting attendee identified as producing sensitive expressions to other meeting attendees. It should be noted that per attendee profiles track counts of sensitive expressions on an attendee basis and embodiments can be configured to provide alerts to meeting managers and Human Resources managers if patterns of sensitive expressions are identified.

In one aspect, embodiments of the present invention can provide a cultural background summary to meeting attendees before a meeting begins to advise meeting attendees of gestures or expressions that might be interpreted as insensitive by some attendees of the meeting.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

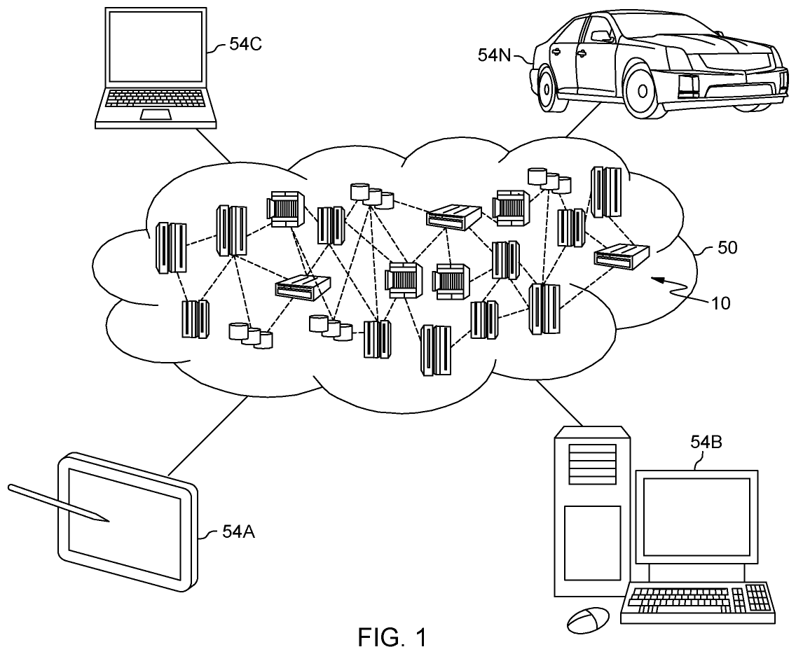

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

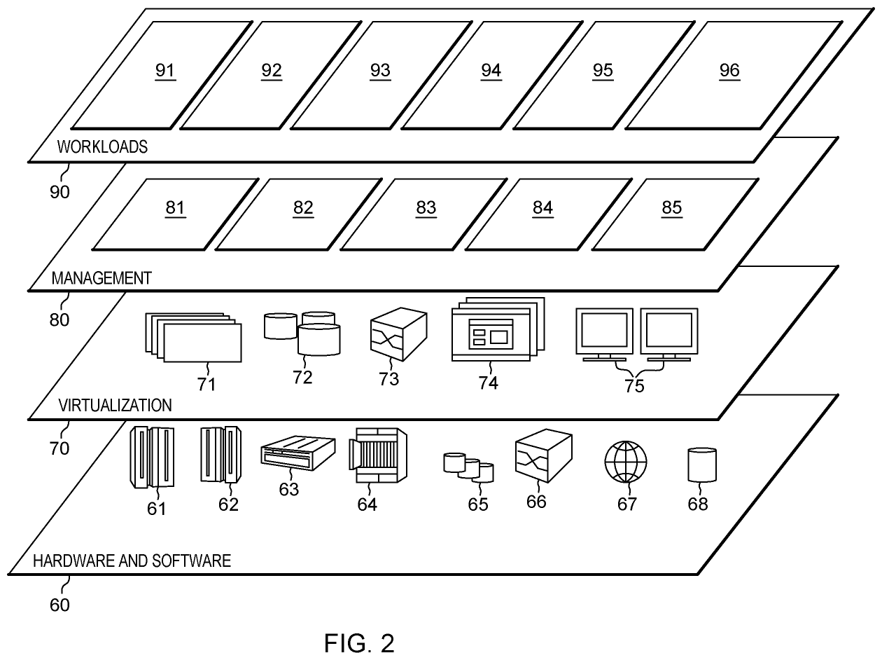

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and sensitive expression detector and attendee alert notifier 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

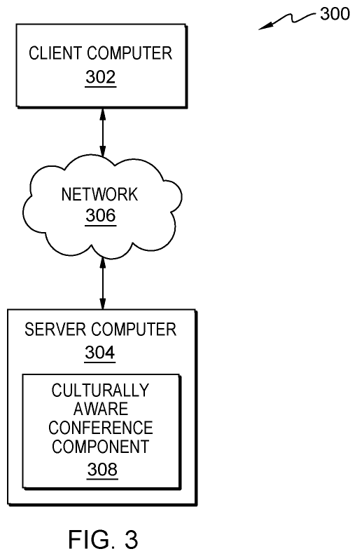

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram showing an exemplary processing system detecting a sensitive expression during a meeting and alerting a meeting attendee producing the sensitive conduct to which the invention principles may be applied. The architecture 300 comprises a client computer 302, a culturally aware conference component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within user persona generation environment via network 306.

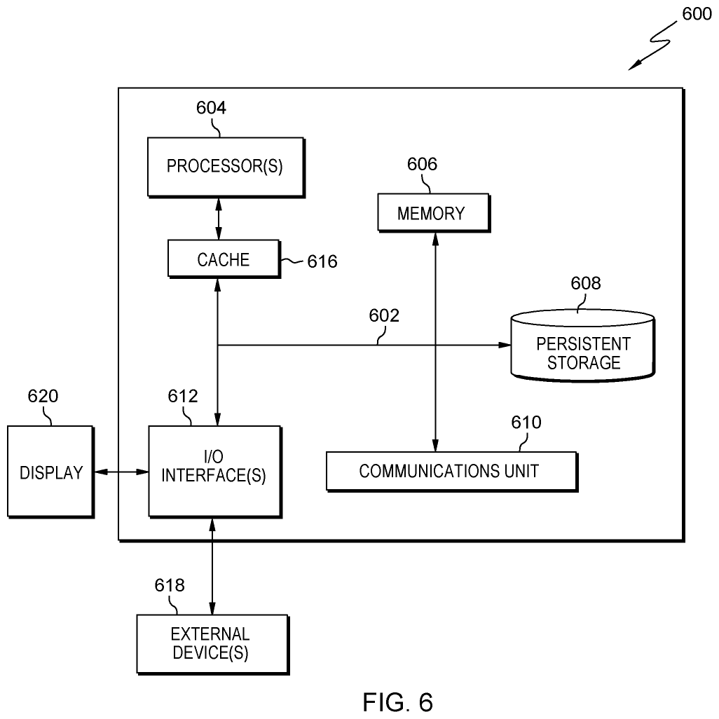

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 6.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within install-time validation environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

Culturally aware conference component 308, operational on server computer 304, can collect audio and video of meeting attendees for real-time and historical analysis. It should be noted that if video is unavailable, a question-answer input mechanism is available to collect user indicated sensitive gesture conditions. It should be noted that the question-answer mechanism can present questions such as, but not limited to,

1a) “Is the topic being discussed perceived as uncomfortable?”;
1b) “Please indicate, on a scale of 1-10 (1=lowest and 10=highest) the level of uncomfortableness”;
2a) “Is this the first time the same or similar topic has been discussed?”;
2b) “If yes, how many times has this topic been expressed by this individual”;
3) “Briefly describe your perception of this topic”;
4) “Describe the offensive aspects of this topic.”

For example, if culturally aware conference component 308 determines that a particular meeting attendee may have been offended by a predicted sensitive expression, then culturally aware conference component 308 can query the particular meeting attendee with one or more questions to determine if the particular meeting attendee was, in fact, offended.

Culturally aware conference component 308 can analyze the audio and/or video input along with any of the aforementioned question/answer input to create a gesture-to-sentiment information mapping database. Culturally aware conference component 308 can retrieve information, from the geographical areas associated with the meeting attendees, of current news, e.g., local, national and international at the scheduled meeting time, social media information, social network data articles, etc. Culturally aware conference component 308 can use the collected information to create individualized sentiment classification databases for the meeting attendees. In another aspect, culturally aware conference component 308 can use the real-time monitoring of the meeting attendees to generate a sentiment analysis of the meeting attendees to recognize sensitive expressions.

In one aspect, during the meeting, culturally aware conference component 308 can correlate, in real-time, attendee expressions and attendee reaction to expressions in light of the aforementioned retrieved information and their associated databases on an attendee basis. It should be noted that attendee expressions can be physical gestures, verbal speech, etc. In another aspect of embodiments of the present invention, culturally aware conference component 308 can determine that predetermined thresholds of sensitive expression have been exceeded and provide feedback to the meeting attendee producing the sensitive expression that a previous expression, identified in the feedback, may have offended a meeting attendee and provide guidance on why the expression was sensitive.

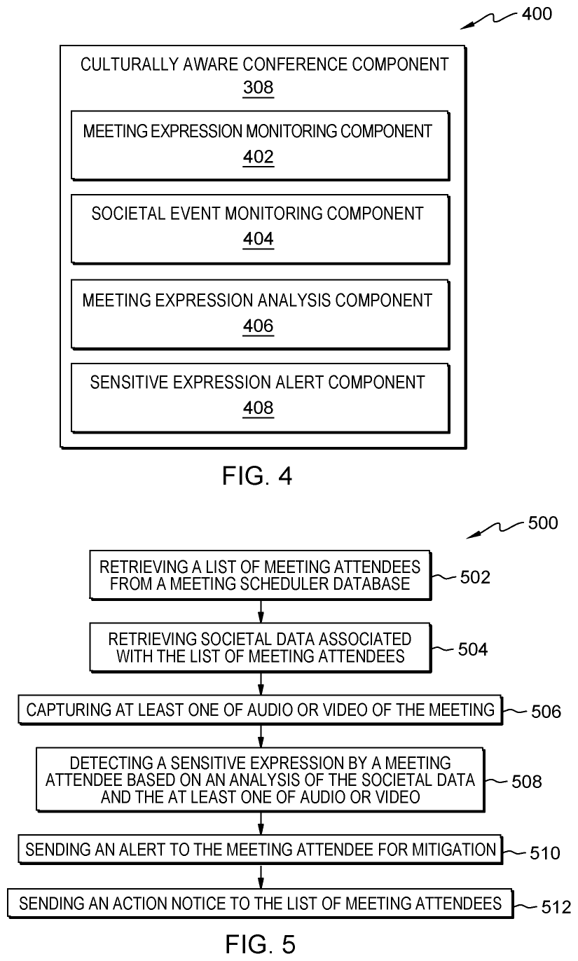

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, more or less elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise a culturally aware conference component 308, which can further comprise a meeting expression monitoring component 402, a societal event monitoring component 404, a meeting expression analysis component 406 and a sensitive expression alert component 408.

In one embodiment, meeting expression monitoring component 402 can collect audio and video of meeting attendees and news/cultural information associated with the meeting attendees. For example, current news from each culture present in the audience such as, but not limited to, the blog “Feedspot” to collect RSS feeds such as, but not limited to ChinesePod Blog RSS Feed, Japan Today Arts & Culture RSS Feed, Christ and Pop Culture RSS Feed, BC Alliance for Arts and Culture RSS Feed, Pop Culture Brain RSS Feed, France 24 Culture RSS Feed, Reddit, etc.

Depending on the identified culture or topic, meeting expression monitoring component 402 can associate a feed to a meeting attendee based on cultural background. For different types of feeds, e.g., religion-based, information can be obtained from user input or from a user profile associated with a “Webex” or “Slack” software application account. It should be noted that prior to any account access, user permission has been granted to allow account access before any personal data is accessed. In another aspect, meeting expression monitoring component 402 can observe, through an audio feed, a video feed and/or meeting attendee manual input, a meeting attendee's reaction to a gesture or verbal expression for analysis. It should be noted that meeting expression monitoring component 402 can store these recordings and observations for later use and analysis.

In one aspect, embodiments of the present invention comprising societal event monitoring component 404 can retrieve data from popular social networks, e.g., Facebook, gesture data from the history associated with the meeting attendees and sentiment data from both the meeting attendee history and external publicly available sentiment databases. It should be noted that the societal event monitoring component 404 can continuously update the databases associated with the meeting attendees as new data is observed or collected. In another aspect, societal event monitoring component 404 can retrieve the news and blog feeds described previously for creating and/or updating databases, e.g., sentiment, associated with meeting attendees.

In another aspect, societal data retrieved by societal event monitoring component 404 can include data such as, but not limited to, cultural background information (CBI), geographical location information (GLI), current event news information (CENI) and social media current event information (SMCEI).

In one embodiment, meeting expression analysis component 406 can predict a sensitive expression based on an analysis of the retrieved news, social and sentiment data and a reaction from a meeting attendee. For example, a meeting attendee, Wang, in China is unaware of a seasonal wildfire threatening the home of a meeting attendee, Ann, in California when he utters the expression “implement a scorched earth policy” in describing a competitors business plan. Meeting expression analysis component 406 can detect that as the expression “scorched earth” is spoken, Ann lowers her head and develops a sad look on her face. Meeting expression analysis component 406 can increment a counter associated with Wang and continue monitoring the meeting. If the counter associated with Wang is above a first predetermined threshold, then meeting expression analysis component 406 can set a first level alert flag for action by sensitive expression alert component 408; if the counter associated with Wang is above a second predetermined threshold, then meeting expression analysis component 406 can set a second level alert flag for action by sensitive expression alert component 408; and if the counter associated with Wang is above a third predetermined threshold, then meeting expression analysis component 406 can set a third level alert flag for action by sensitive expression alert component 408.

Meeting expression analysis component 406 can update databases associated with Wang, indicating his utterance of sensitive expression and can update databases associated with Ann indicating a sensitive topic for future reference. It should be noted that the updates for Wang can be used to suggest future corporate training and the updates for Ann can be used to monitor for similar type events in the geographical area and to suggest the use of corporate services associated with managing the event associated with the sensitivity.

Further, meeting expression analysis component 406 can process the data from the aforementioned sources of information and, in real-time, analyze the expression, expression reaction, the feedback expression reaction answers, and the trending news and/or social media/network feed. It should be noted that the trending feeds are evaluated from a predetermined time period before the present time up to the present time. Meeting expression analysis component 406 can perform correlations via known in the art correlation techniques such as statistical measurements to determine co-relationships or associations of all the associated variables. For example, a key-value pairs dataset constructed with keys as variables and collecting content from a gesture-to-sentiment map data, flagged user counter map data, trending news data, cultural background data, social network feeds data, etc.

In another aspect, embodiments of the present invention via meeting expression analysis component 406 can perform pattern analysis to determine, based on sentiment data, if for an individual or individuals, a particular expression was determined as inappropriate, negative, sensitive, and/or controversial. Meeting expression analysis component 406 can further map a sensitive expression to a meeting attendee (sensitive expression author) and meeting expression analysis component 406 can also sub-map a sensitive expression to an affected audience of meeting attendees.

In one embodiment of the present invention, sensitive expression alert component 408 can monitor the sensitive expression counters associated with meeting attendees with respect to predetermined thresholds. If sensitive expression alert component 408 detects a counter above a first predetermined threshold, then sensitive expression alert component 408 can send a notification/alert to the meeting attendee associated with the counter advising them of the sensitive expression and the reason the expression is sensitive. If configured appropriately, sensitive expression alert component 408 can also provide the identity of the meeting attendee sensitive to the expression. In another aspect, sensitive expression alert component 408 can instruct the meeting attendee to refrain from repeating the sensitive expression.

In one aspect, if embodiments of the present invention, through sensitive expression alert component 408, detect a counter above a second predetermined threshold for an associated meeting attendee, then sensitive expression alert component 408 can send a notification to the meeting attendee associated with the counter advising them of the sensitive expression and the reason the expression is sensitive. Sensitive expression alert component 408 can also send a copy of the notification to the meeting manager. If configured appropriately, sensitive expression alert component 408 can also provide the identity of the meeting attendee sensitive to the expression to the meeting attendee and/or the meeting manager.

In another aspect, if embodiments of the present invention, through sensitive expression alert component 408, detect a counter above a third predetermined threshold for an associated meeting attendee, then sensitive expression alert component 408 can send a notification to the meeting attendee associated with the counter advising them of the sensitive expression and the reason the expression is sensitive. Sensitive expression alert component 408 can also send a copy of the notification to the meeting manager and to a Human Resource (HR) manager associated with the meeting attendee. If configured appropriately, sensitive expression alert component 408 can also provide the identity of the meeting attendee sensitive to the expression to the meeting attendee and/or the meeting manager and/or the HR manager.

It should be noted that the aforementioned counter can be a single counter or multiple counters associated with the different thresholds based on a desired implementation.

FIG. 5 is an exemplary flowchart of a method 500 for detecting a sensitive expression during a meeting and alerting one or more meeting attendees. At step 502, an embodiment can retrieve, via culturally aware conference component 308, a list of meeting attendees from a meeting scheduler database. At step 504, the embodiment can retrieve societal data, via societal event monitoring component 404. At step 506, the embodiment can capture at least one of audio, video or meeting attendee input from the meeting, via meeting expression monitoring component 402. At step 508, the embodiment can detect, via meeting expression monitoring component 402, a sensitive expression by a meeting attendee based on an analysis, via meeting expression analysis component 406, of the societal data and the at last one of audio, video or meeting attendee input. At step 510, the embodiment can send, via sensitive expression alert component 408, an alert to the meeting attendee for mitigation. At step 512, the embodiment can send, via sensitive expression alert component 408, an action notice to the meeting attendees.

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting a sensitive expression during a meeting and alerting one or more meeting attendees, the computer-implemented method comprising:
retrieving a list of meeting attendees from a meeting scheduler database;
retrieving societal data associated with the list of meeting attendees;
capturing at least one of audio or video of the meeting;
detecting a sensitive expression by a meeting attendee based on an analysis of the societal data and one or more of meeting attendee input and the at least one of audio or video;
sending an alert to the meeting attendee based on the detecting; and
sending an action notice to the list of meeting attendees based on the detecting.

2. The computer-implemented method of claim 1, further comprising:
storing the sensitive expression in a profile associated with the meeting attendee;
incrementing a first counter in the profile indicating a count of sensitive expressions by the meeting attendee; and
responsive to the first counter exceeding a first predetermined threshold, sending an alert requesting intervention with the meeting attendee to a conference manager associated with the meeting and incrementing a second counter in the profile.

3. The computer-implemented method of claim 2, further comprising:
responsive to the second counter exceeding a predetermined threshold, sending an alert requesting intervention with the meeting attendee to a human resources manager associated with the meeting attendee.

4. The computer-implemented method of claim 1, wherein the societal data comprises cultural background information (CBI), geographical location information (GLI), current event news information (CENI) and social media current event information (SMCEI).

5. The computer-implemented method of claim 4, wherein a portion of the CBI, GLI, CENI and SMCEI is input by a meeting attendee associated with the information.

6. The computer-implemented method of claim 1, wherein the sensitive expression comprises one or more of gestures, words, phrases or topics of conversation.

7. The computer-implemented method of claim 4, wherein the sensitive expression is identified for a meeting attendee based on SMCEI associated with the meeting attendee.

8. A computer program product for detecting a sensitive expression during a meeting and alerting one or more meeting attendees, the computer program product comprising:
one or more non-transitory computer readable storage media and program instructions stored on the one or more non-transitory computer readable storage media, the program instructions comprising:
program instructions to retrieve a list of meeting attendees from a meeting scheduler database;
program instructions to retrieve societal data associated with the list of meeting attendees;
program instructions to capture at least one of audio or video of the meeting;
program instructions to detect a sensitive expression by a meeting attendee based on an analysis of the societal data and one or more of meeting attendee input and the at least one of audio or video;
program instructions to send an alert to the meeting attendee based on the detecting; and
program instructions to send an action notice to the list of meeting attendees based on the detecting.

9. The computer program product of claim 8, further comprising:
program instructions to store the sensitive expression in a profile associated with the meeting attendee;
program instructions to increment a first counter in the profile indicating a count of sensitive expressions by the meeting attendee; and
responsive to the first counter exceeding a first predetermined threshold, program instructions to send an alert requesting intervention with the meeting attendee to a conference manager associated with the meeting and incrementing a second counter in the profile.

10. The computer program product of claim 9, further comprising:
responsive to the second counter exceeding a predetermined threshold, program instructions to send an alert requesting intervention with the meeting attendee to a human resources manager associated with the meeting attendee.

11. The computer program product of claim 8, wherein the societal data comprises cultural background information (CBI), geographical location information (GLI), current event news information (CENI) and social media current event information (SMCEI).

12. The computer program product of claim 11, wherein a portion of the CBI, GLI, CENI and SMCEI is input by a meeting attendee associated with the information.

13. The computer program product of claim 8, wherein the sensitive expression comprises one or more of gestures, words, phrases or topics of conversation.

14. The computer program product of claim 11, wherein the sensitive expression is identified for a meeting attendee based on SMCEI associated with the meeting attendee.

15. A computer system for detecting a sensitive expression during a meeting and alerting one or more meeting attendees, the computer system comprising:
one or more computer processors;
one or more non-transitory computer readable storage media; and
program instructions stored on the one or more non-transitory computer readable storage media, the program instructions comprising:
program instructions to retrieve a list of meeting attendees from a meeting scheduler database;
program instructions to retrieve societal data associated with the list of meeting attendees;
program instructions to capture at least one of audio or video of the meeting;
program instructions to detect a sensitive expression by a meeting attendee based on an analysis of the societal data and one or more of meeting attendee input and the at least one of audio or video;
program instructions to send an alert to the meeting attendee based on the detecting; and
program instructions to send an action notice to the list of meeting attendees based on the detecting.

16. The computer system of claim 15, further comprising:
program instructions to store the sensitive expression in a profile associated with the meeting attendee;
program instructions to increment a first counter in the profile indicating a count of sensitive expressions by the meeting attendee; and
responsive to the first counter exceeding a first predetermined threshold, program instructions to send an alert requesting intervention with the meeting attendee to a conference manager associated with the meeting and incrementing a second counter in the profile.

17. The computer system of claim 16, further comprising:
responsive to the second counter exceeding a predetermined threshold, program instructions to send an alert requesting intervention with the meeting attendee to a human resources manager associated with the meeting attendee.

18. The computer system of claim 15, wherein the societal data comprises cultural background information (CBI), geographical location information (GLI), current event news information (CENI) and social media current event information (SMCEI), and wherein the sensitive expression is identified for a meeting attendee based on at least SMCEI associated with the meeting attendee.

19. The computer system of claim 18, wherein a portion of the CBI, GLI, CENI and SMCEI is input by a meeting attendee associated with the information.

20. The computer system of claim 15, wherein the sensitive expression comprises one or more of gestures, words, phrases or topics of conversation.
